(19) United States
(12) Patent Application Publication
(10) Pub. No.: US 2015/0052021 A1
(43) Pub. Date: Feb. 19, 2015

(54) SYSTEM AND METHOD FOR PROCESSING SERVICE QUERIES

(71) Applicant: Red Hat, Inc., Raleigh, NC (US)

(72) Inventors: Filip Eliás, Vysni Lhoty (CZ); Filip Nguyen, Brno (CZ)

(73) Assignee: Red Hat, Inc., Raleigh, NC (US)

(21) Appl. No.: 13/970,555

(22) Filed: Aug. 19, 2013

(51) Int. Cl. G06Q 30/06

(52) U.S. Cl. CPC G06Q 30/0627
USPC 705/26.63

(57) ABSTRACT

A system and method of processing service queries includes receiving a first request for services from a client, the first request for services includes a service query including identifiers for an action, one or more candidate services, a services template, and an aggregation; parsing the services query to identify the action, the candidate services, the services template, and the aggregation; determining one or more combinations of candidate services based on types of the candidate services; applying the services template to each of the combinations of candidate services to determine results for each of the combinations of candidate services; aggregating the results based on the aggregation; selecting a preferred combination of candidate services based on the applied aggregation; and forwarding the results corresponding to the preferred combination to the action.

### BACKGROUND

The present disclosure relates generally to computing systems, and more particularly to processing of service queries.

As the value and use of information continues to increase, individuals and businesses seek additional ways to process and store information. One option is a computing system. Computing systems may vary in complexity from a single processor operating in relative isolation to large networks of interconnected processors. The interconnected processors may be in close proximity to each other or separated by great distances both physically and as distance is measured in computer networking terms. The interconnected processors may also work together in a closely cooperative fashion or in a loose weakly coupled fashion. Because technology and processing needs and requirements may vary between different applications, the structure and arrangement of the computing system may vary significantly between two different computing systems. The flexibility in computing systems allows them to be configured for both specific users, specific uses, or for more general purposes. Computing system may also include a variety of hardware and software components that may be configured to process, store, and communicate information based on the needs of the users and the applications.

Additionally, some examples of computing systems include non-transient, tangible machine-readable media that include executable code that when run by one or more processors, may cause the one or more processors to perform the steps of methods described herein. Some common forms of machine readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Computers, processors, and software systems often share information and provide computing services for each other. In order to do so, a server or some other computing system may provide an interface through which service requests are made by the other computing devices or clients. In these service-oriented architectures (SOAs), the clients may make a request for services by sending a request message to the server hosting the service using, for example, a networking protocol. The server receives the message, activates the requested service, and returns a response message with the result. For example, a very basic form of services is demonstrated by a request for a web page. A client, such as a web browser, sends a Hypertext Transport Protocol (HTTP) request to a web server which receives the HTTP request and generates a response containing the requested web page that is returned to the web browser. Most computing systems and clients have access to many servers providing a large array of services that the clients may use. In some cases an enterprise services bus (ESB) such as the JBoss® ESB provided by Red Hat, Inc., may be useful for directing and managing requests for services requests made by clients.

To avoid unnecessarily complicating services, most services operate in a stateless fashion. This means that the services retain no information between successive uses of the services, even between successive uses of a same service by a same client. This works well in many situations, including the basic serving of web pages, but may not be adequate in others. Numerous solutions exist for adding state to services including cookies, session IDs, and/or adding more complex state-recording data structures in the servers hosting the services. When these solutions are not available, the client must manage the handling of states between services calls using a custom application with suitable variables, data structures, etc. to maintain the state between services calls.

Accordingly, it would be desirable to provide improved systems and methods for adding state and state-like features to services that do not otherwise support such features.

### SUMMARY

According to one example, a method of processing a request for services includes receiving a first request for services from a client, the first request for services includes a service query including identifiers for an action, one or more candidate services, a services template, and an aggregation; parsing the services query to identify the action, the candidate services, the services template, and the aggregation; determining one or more combinations of candidate services based on types of the candidate services; applying the services template to each of the combinations of candidate services to determine results for each of the combinations of candidate services; aggregating the results based on the aggregation; selecting a preferred combination of candidate services based on the applied aggregation; and forwarding the results corresponding to the preferred combination to the action.

According to another example, a service query system includes a router; a gateway that receives a first request for services from a client, the request for services comprising a service query including identifiers for an action, one or more candidate services, a services template, and an aggregation; an expander that receives the service query from the gateway and determines one or more combinations of candidate services based on types of the candidate services; a consolidator that receives the combinations of candidate services from the expander, applies the services template to each of the combinations of candidate services to determine results for each of the combinations of candidate services by sending one or more second requests for services to the candidate services using the router, aggregates the results based on the aggregation, and selects a preferred combination of candidate services based on the applied aggregation; and an orchestrator that receives the results and the preferred combination of candidate services from the consolidator and forwards the results corresponding to the preferred combination to the action by sending a third request for service to the action using the router.

According to yet another example, a non-transitory machine-readable medium comprising a first plurality of machine-readable instructions which when executed by one or more processors associated with an enterprise services bus (ESB) are adapted to cause the one or more processors to perform a method. The method includes receiving a first request from a client, the first request comprising an ESB query language (EQL) statement including clauses for designating an action, one or more services, a template, and a consolidation function; parsing the EQL statement to identify the action, the services, the template, and the consolidation function; separating the services into one or more sets based on types of the services, each of the one or more sets including services of a corresponding type selected from the types; forming groups of services by generating different combinations of services by selecting one service from each of the sets; for each group in the groups of services, sending corresponding second requests to each of the services in the group based on the template and receiving corresponding responses; consolidating the responses to the second requests based on the consolidation function; selecting a preferred group of services from the groups of services based on the results of the consolidation; sending a third request, including the results corresponding to the preferred group of services, to the action; and receiving a response from the action.

### BRIEF DESCRIPTION OF THE DRAWINGS

FIG. 1 is a simplified diagram of a service-oriented architecture (SOA) according to some examples.

FIG. 2 is a simplified diagram of a computing system according to some examples.

FIG. 3 is a simplified diagram of a grammar for an ESB Query Language (EQL) query according to some examples.

FIG. 4 is a simplified diagram of a method of EQL query processing according to some examples.

FIG. 5 is a simplified diagram of the processing of an EQL query using the method of FIG. 4 according to some examples.

In the figures, elements having the same designations have the same or similar functions.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

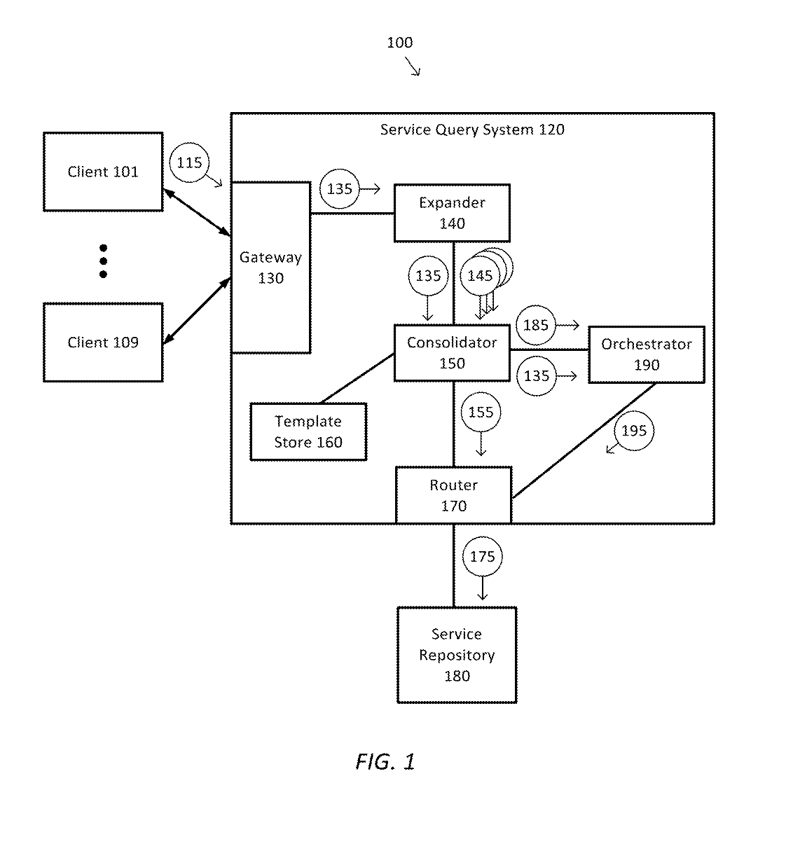

FIG. 1 is a simplified diagram of a service-oriented architecture (SOA) 100 according to some examples. As shown in FIG. 1, SOA 100 is built around a client-services model. In SOA 100, requests for services originate from one or more clients 101-109. Rather than make all their requests for services directly, clients 101-109 may make some of their requests for services through other systems. One such system is illustrated in FIG. 1, where a request for service 115 is directed to a service query system 120. In some examples, service query system 120 may be an extension to an ESB. Unlike a typical ESB, an ESB extended by service query system 120 may support state and other useful consolidation and/or aggregation functions among existing services. This may reduce the cost and time to deliver client applications because service query system 120 may add these functions to existing services without the client applications implementing state, consolidation, aggregation, and/or other similar features associated with one or more services.

Clients 101-109 may transmit their request for services 115 to service query system 120 through a gateway 130. Gateway 130 provides an interface for receiving requests for services, like request for services 115. For example, service query system 120 may implement gateway 130 using an application programming interface (API), a collection of remote procedure calls, a collection of web services, and/or the like. In general, gateway 130 may receive requests for services by receiving messages using any suitable protocol. In some examples, the protocol may include HTTP, HTTP Secure (HTTPS), Simple Object Access Protocol (SOAP), Java Messaging System (JMS), and/or the like.

Once the request for service 115 is received at gateway 130, request for service 115 is parsed and/or analyzed to determine which type of service is being requested. In some examples, when the requested service is a basic service request for an existing service, integration system 120 may act as a proxy for the request and forward it to the designated service. In this situation, when service query system 120 receives a response from the provider of the requested service, service query system 120 may return it to the requesting client.

Service query system 120 further includes the ability to receive requests for services using an ESB query language (EQL). The EQL uses a query-like syntax to allow a client to add short-term state and/or frequently used consolidation and/aggregation features to one or more existing services that may be useful when solving many routinely encountered computing problems. In some examples, short-term state, consolidation, and aggregation may be useful when selecting and then using a best service or vendor. For example, an EQL statement or query may be used to determine costs for a purchase order from multiple vendors, select the vendor with the lowest price, and place the order with the selected vendor without develop a custom application that iterates through all the vendors checking prices, selecting the lowest priced vendor, and then placing the order. In some examples, short-term state, consolidation, and aggregation may also be useful when selecting from among two or more services that provide the same functionality, such as processing of files, etc.

According to some examples, one of the clients 101-109 may indicate that its request includes an EQL query 135 by including a special field and/or header into the request for services 115. When EQL query 135 is detected, EQL query 135 is forwarded to an expander 140. In some examples, request for services 115 may further include a body with one or more data items that are to be processed by one or more services identified in EQL query 135. For example, when EQL query 135 is used to process a purchase order, the body may include a list of items to order.

Expander 140 examines EQL query 135 to identify all of the possible candidate services that may be used to process EQL query 135. In many situations it may take a combination of candidate services to satisfy EQL query 135 with each candidate service in the combination supplying part of the processing. For example, multiple suppliers, each with its own ordering service, may be used in order to supply all of the items listed in a purchase order. Expander 140 may determine when combinations of services are present by determining a type of each of the candidate services included in EQL query 135. When two candidate services are of different types, expander 140 may determine that a candidate service of each type should be used to satisfy EQL query 135. In some examples, when EQL query 135 includes n types of candidate services, expander 140 may determine that a combination of n candidate services, one of each type, should be used to satisfy EQL query 135.

In some examples, expander 140 may determine a type of each of the candidate services by examining metadata stored by the ESB or other server that is being enhanced by service query system 120. In some examples, the metadata is provided by a provider of a respective service when the respective service is registered with the ESB or other server. The metadata may be stored by the ESB or other server in one or more data structures, databases, and/or the like. The metadata may further include location and/or other information for each of the candidate services including a uniform resource locator (URL), an end point record, an interface type, and/or the like.

Once expander 140 has identified the type of each of the candidate services, expander 140 separates the candidate services into sets, with each set including the one or more candidate services of a respective type. Expander 140 then selects one candidate service from each set to form a combination or tuple of candidate services. Expander 140, in effect, generates a Cartesian product of the sets 145. Each combination of candidate services in the Cartesian product 145 represents a possible best selection for satisfying EQL query 135 and request for services 115. For example, when expander 140 determines that there are four candidate services of a first type and two candidate services of a second type that are included in EQL query 135, 8=4*2 combinations of candidate services 145 are generated by expander 140.

The combinations of candidate services 145 are collectively forwarded to a consolidator 150 for further processing along with EQL query 135. Consolidator 150 examines EQL query 135 to identify a services template that may be used to combine and apply each of the candidate services included in each of the combinations of candidate services 145. In some examples, the services template may include placeholders that direct consolidator 150 how to use and apply each of the candidate services. In some examples, the services template may further include script and/or script-like elements to further direct the usage of each of the candidate services. In some examples, consolidator 150 may retrieve the services template from a template store 160 by using a services template name or other identifier included in EQL query 135.

Using the services template, consolidator 150 generates one or more requests for services including a request for services 155 that are directed to each of the respective candidate services in the combinations of candidate services 145. In some examples, data from the body of request for services 115 may be included in the request for services 155. The request for services 155 is then directed to a router 170 that may forward request for services 155 as a request for services 175 to the corresponding candidate service in a service repository 180. After request for services 175 is processed by the candidate service, the response is returned to router 170 which, in turn, returns the response to consolidator 150.

Upon receiving the response to request for services 155, the consolidator may temporarily store the response for further processing. In some examples, consolidator 150 may use one or more filters to determine that one or more of the responses to the various requests for service 155 do not meet a particular criterion. For example, EQL query 135 may include a filter specifying that all ordered products should be shipped within 10 days. A candidate service and/or a combination of candidate services that cannot meet this filter may be excluded by consolidator 150. In some examples, consolidator 150 may use one or more aggregators to aggregate the responses between each of the combinations of candidate services 155. The one or more aggregators may include statistical functions such as min, max, average, median, and/or the like. For example, EQL query 135 may include a min aggregator that directs consolidator 150 to select the combination of candidate services that results in the lowest cost to fulfill a purchase order.

Consolidator 150 may generate and forward requests for service to each of the candidate services in each of the combinations of candidate services 145 in any order. In some examples, consolidator 150 may iterate through each of the requests for service making each request in turn and waiting for the corresponding response before proceeding with the next. In some examples, consolidator 150 may use threading and/or other parallelization approaches to forward multiple requests for services in parallel.

Once consolidator 150 has applied the services template to each of the combinations of candidate services and further applied any filters and/or aggregations included in EQL query 135, consolidator 150 may select one of the combinations of candidate services for further processing. The responses 185 from the corresponding candidate services are then forwarded to an orchestrator 190 for further processing along with EQL query 135.

Orchestrator 190 may further examine EQL query 135 to determine one or more actions to perform on the responses 185 received from consolidator 150. In some examples, each of the actions may be implemented using other services that may be included in service repository 180. In some examples, orchestrator 190 may forward a corresponding request for services 195 to router 170 which, in turn forwards request for services 195 to the service implementing the action. In some examples, a body of request for services 195 may include all or part of the responses 185. The service implementing the action may then return a response to router 170. This response is then ultimately returned to the client which made the original request for service 115, thus completing processing of EQL query 135.

The use of service query system 120 in SOA 100 may provide several advantages over other client-services approaches. Service query system 120 provides a convenient approach to iterating through potentially large numbers of candidate services and/or combinations of candidate services. Service query system 120 further supports the use of short-term state that is convenient for computing common aggregations and statistics related to multiple services and combinations of services.

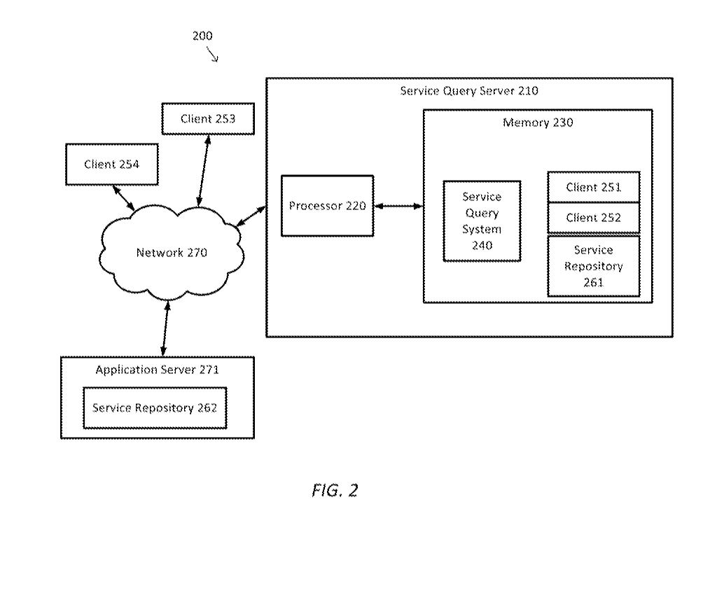

FIG. 2 is a simplified diagram of a computing system 200 according to some examples. As shown in FIG. 2, computing system 200 illustrates a representative example of how a service query system, such as service query system 120 may be implemented in a networking and/or ESB environment. Computing system 200 includes a service query server 210. In some examples, service query server 210 may be a standalone workstation, a cluster, a production server, within a virtual machine, and/or the like. In some examples, service query server may be associated with an ESB server. Service query server 210 includes a processor 220 coupled to memory 230. In some examples, processor 220 may control operation and/or execution of hardware and/or software on service query server 210. Although only one processor 220 is shown, service query server 210 may include multiple processors and/or multi-core processors. Memory 230 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Memory 230 may be used to store a service query system 240. In some examples, service query system 240 may be consistent with service query system 120. Service query system 240 includes one or more interfaces for receiving one or more requests for services that include an EQL query from one or more clients. Memory 230 may also be used to store one or more clients, including representative clients 251 and 252. Each of clients 251 and 252 may be similar to clients 101-109 and make one or more requests for services to service query system 240. Although not explicitly shown in FIG. 2, service query system 240 and clients 251 and 252 may be hosted in one or more virtual machines and/or Java virtual machines running on service query server 210.

Service query server 210 may also host one or more service repositories, such as a representative service repository 261. In some examples, service repository 261 may be service repository 180. Like clients 251 and 252, service repository 261 may be hosted in one or more virtual machines and/or Java virtual machines running on service query server 210.

Service query server 210 and service query system 240 may also receive and support requests for services from clients located outside service query server 210. As shown in FIG. 2, service query server 210 may be coupled to a network 270. Network 270 may be any kind of network, including a local area network (LAN), such as an Ethernet, and/or a wide area network (WAN), such as an internet. Several representative clients outside of service query server 210 are shown in FIG. 2, including clients 253 and 254. Each of clients 253 and 254 may be similar to clients 101-109 and use service query system 240 to process one or more requests for service that include an EQL query.

Further coupled to service query server 210 using network 270 are one or more application servers, such as a representative application server 271. Application server 271 may host one or more services accessible to service query system 240. In some examples, the one or more services form a service repository 262. In some examples, service repository 262 may be similar to service repository 180. FIG. 2 demonstrates the flexibility of service query system 240 as it may be used with any number of clients, application servers, and/or service repositories.

Although not explicitly shown in FIG. 2, clients 251-254 and/or service repositories 261-262 may each be hosted in their own workstation, server, and/or computing device and/or hosted in any number and combination of workstations, servers, and/or computing devices, each with one or more processors and memory. In some examples, any of the clients 251-254, and/or service repositories 261-262 may be hosted on service query server 210. In some examples, each of clients 251-254 and/or service repositories 261-262 may further be hosted in one or more virtual machines and/or Java virtual machines running on the workstations, servers, and/or computing devices.

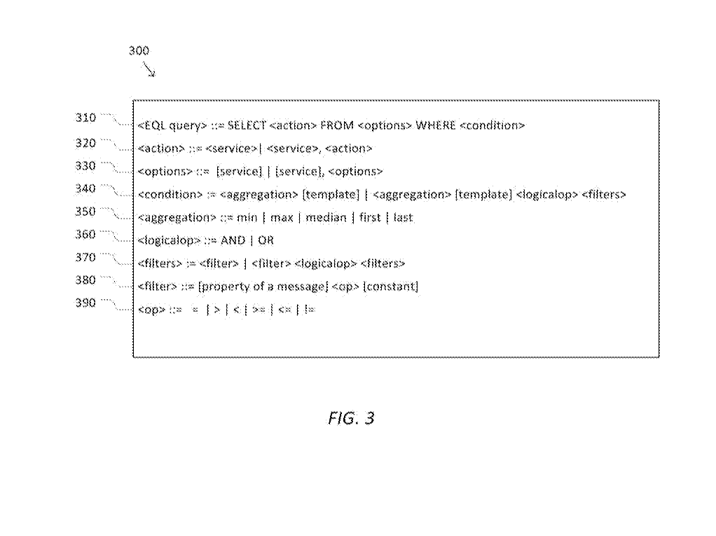

FIG. 3 is a simplified diagram of a grammar 300 for an EQL query according to some examples. As shown in FIG. 3, grammar 300 is expressed as a context-free grammar in Backus-Naur Form (BNF). Consistent with BNF, elements in < and > represent placeholders that may be substituted for other elements in the grammar as noted by the “::=” notation. Elements in [ and] represent abstract elements that represent context dependent substitutions such as the name of a service, the name of a services template, etc. The | indicates that there are multiple substitution options that may be selected from.

An <EQL query> placeholder 310 is a top placeholder that describes an EQL query. Under grammar 300, an EQL query includes structured query language (SQL) like syntax including a SELECT clause containing an action, a FROM clause containing services options, and a WHERE clause for helping select from among the one or more services options.

An <action> placeholder 320 describes possible actions that may be executed to satisfy an EQL query. The <action> placeholder 320 forms a body of the SELECT clause. The action may be a single service or a list of services. In some examples, the one or more services that form the action may be the services invoked by orchestrator 190.

An <options> placeholder 330 describes possible service options that may be selected from to satisfy an EQL query. The <options> placeholder 330 forms a body of the FROM clause. The options may be a single service or a list of services. In some examples, the one or more services that form the options are the candidate services that are examined by expander 140 to create the combinations of selected services 145.

A <condition> placeholder 340 describes possible conditions that may be used to select from among the candidate services include in the FROM clause. The <condition> placeholder 340 forms a body of the WHERE clause. The condition may describe an aggregation and a services template or an aggregation and a services template in logical combination with one or more filters. In some examples, the <condition> placeholder 340 may be used by consolidator 150 to determine the type of aggregation to perform and to select from among the combinations of candidate services 145.

An <aggregation> placeholder 350 describes the aggregations supported by an EQL query that may be used to select from and/or aggregate the one or more candidate services in the FROM clause. The aggregations may include common selection and/or statistical functions such as min, max, median, average, first, last, and/or the like. Although only a limited number of aggregations are described by the <aggregation> placeholder 350, other aggregations are possible in other EQL grammars.

A <logicalop> placeholder 360 describes possible logical operators that may be used combine an aggregation with one or more filters. The logical operators include logical AND and logical OR. As with the aggregations, other logical operations are possible in other EQL grammars.

A <filters> placeholder 370 describes that when filters are included in the WHERE clause, any number of one or more filters may be used and combined using logical operations. Each filter is described by a <filter> placeholder 380 as a combination of property of a message with a constant. An <op> placeholder 390 describes that the property of a message is compared to the constant using a mathematical comparison operation. Although only simple filters are described by EQL grammar 300, other more complex comparisons are possible with other EQL grammars. In some examples, the more complex comparisons may include comparisons between multiple properties of a message, use of other mathematical operations such as addition and multiplication, and/or the like.

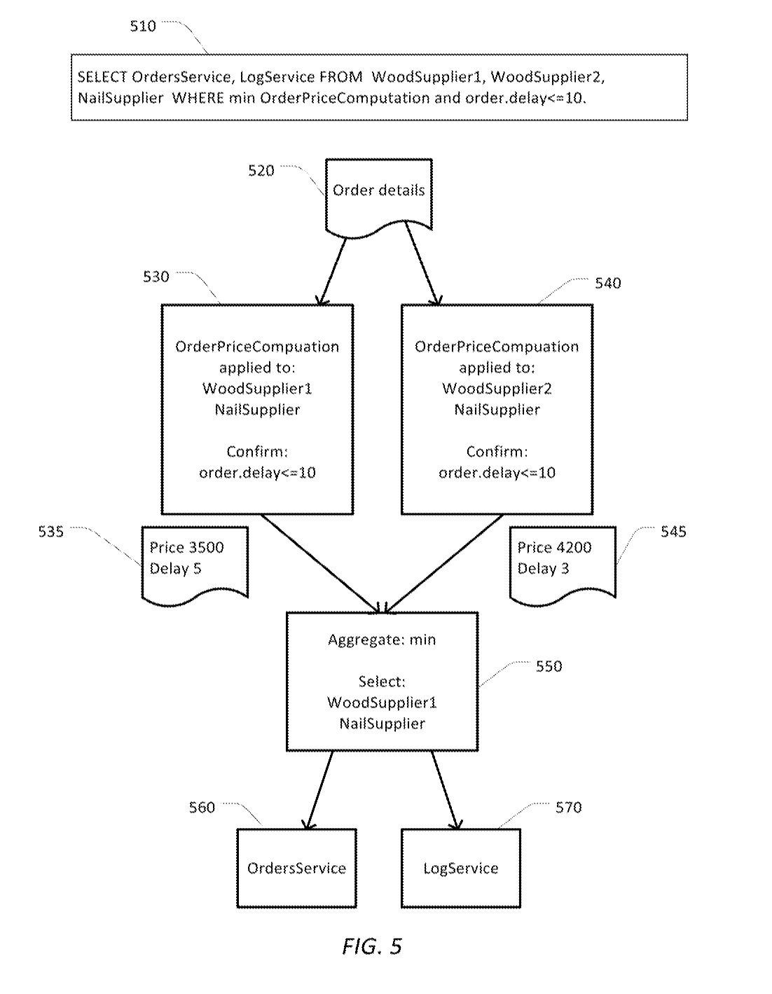

Examples of the use of EQL grammar 300 are described in further detail in FIG. 5.

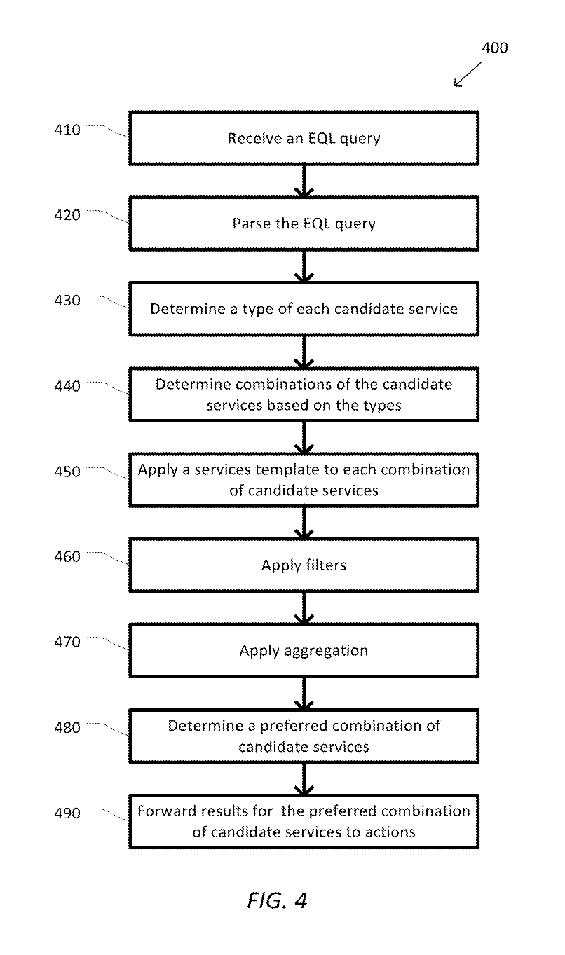

FIG. 4 is a simplified diagram of a method 400 of EQL query processing according to some examples. In some examples, one or more of the processes 410-490 of method 400 may be implemented, at least in part, in the form of executable code stored on non-transient, tangible, machine readable media that when run by one or more processors (e.g., the processor 220 of service query server 210) may cause the one or more processors to perform one or more of the processes 410-490. In some examples, method 400 may be used by service query system 120 and/or 240 to receive an EQL query, perform expansion, consolidation, and orchestration on the EQL query, and generate a response.

At a process 410, an EQL query or services query is received. In some examples, the EQL query may be part of a request for services that may be received by a gateway of a service query system like service query system 120 and/or 240. In some examples, the request for services may be received from a client of the service query system, such as any of the clients 101-109 and/or 251-254. In some examples, the EQL query may be formatted according to the EQL grammar 300. In some examples, the request for services may be request for services 115 and the EQL query may be EQL query 135.

At a process 420, the EQL query is parsed. The EQL query is parsed to determine the actions, options, and conditions that form the SELECT, FROM, and WHERE clauses, respectively, of the EQL query. In some examples, the EQL query may be parsed by the service query system. In some examples, the EQL query may be parsed to determine one or more services that form the actions, one or more candidate services that form the options, and/or an aggregation and a services template that form the conditions. In some examples, the parsing may further identify one or more filters that may also be part of the conditions.

At a process 430, a type of each candidate service is determined. For each of the candidate services identified during process 420, a type for that service is determined. In some examples, the type may be determined by an expander, such as expander 140. In some examples, the type may be determined by accessing metadata associated with the corresponding candidate service that is kept by the service query system. In some examples, the metadata may be previously received when the corresponding candidate service was registered with the service query system and/or an ESB.

At a process 440, one or more combinations of candidate services are determined based on the types of the candidate services. Once the type of each of the candidate services is determined using process 430, the candidate services are divided into sets based on the types of the respective candidate services. Each set includes the candidate services of a respective type. One candidate service in then selected from each set to form a combination or tuple of candidate services. For example, when there are three candidate services of a first type, two candidate services of a second type, and four candidate services of a third type included in the EQL query, 24=3*2*4 combinations or tuples of candidate services are determined. In some examples, when the candidate services are all of a same type, each combination of candidate services includes only a single candidate service. In some examples, process 440 may be performed by expander 140 to generate the combinations of candidate services 145.

At a process 450, a services template is applied to each combination of candidate services. Each combination of candidate services determined during process 440 is used according to the services template identified during process 420. Based on the services template, one or more requests for service may be made to each of the candidate services in each of the combinations of candidate services. After making each request for service, a response is received from the respective candidate service and the response is retained for further processing. In some examples, the services template may include one or more placeholders indicating how the request for service for each of the candidate services in the combinations of candidate services may be made. In some examples, the candidate services may be found in one or more service repositories. In some examples, the services template may be retrieved from a template store, such as template store 160. In some examples, the process 450 may be performed by consolidator 150.

At a process 460, filters may be applied. When one or more filters are identified during process 420, the one or more filters may be applied to the responses to the requests for services received during process 450. In some examples, the one or more filters may be used to reject one or more of the combinations of candidate services that do not meet one or more corresponding criteria identified in the EQL query. In some examples, the process 460 may be performed by consolidator 150.

At a process 470, an aggregation may be applied. When one or more aggregations are identified during process 420, the one or more aggregations are applied to any of the responses to the requests for services received during process 450 that are not filtered out during process 460. In some examples, the one or more aggregations may be used to identify the combination of candidate services that best satisfies the EQL query. In some examples, the one or more aggregations may perform further statistical analysis on the responses. In some examples, the process 470 may be performed by consolidator 150.

At a process 480, a preferred combination of candidate services is determined. Based on the results of the aggregation applied during process 470, the preferred combination of candidate services is selected. For example, when the aggregation is a minimum function, the combination of candidate services resulting in the smallest value is selected as the preferred combination of candidate services. In some examples, the process 480 may be performed by consolidator 150.

At a process 490, results for the preferred combination of candidate services are forwarded to one or more actions. The results corresponding to the preferred combination of candidate services determined during process 480 are forwarded to the one or more actions determined during process 420. In some examples, the results may include the one or more responses to the requests for service corresponding to the candidate services of the preferred combination of candidate services that were retained during process 450. In some examples, the results may further include information associated with the one or more aggregations applied during process 470. In some examples, the process 490 may be performed by orchestrator 190.

Although not shown as an explicit process step in FIG. 4, in some examples, method 400 may further include a process for returning the responses received from the one or more services included in the actions to the client that provided the request for services that included the EQL query received during process 410. In some examples, method 400 may further include one or more error response processes for handling EQL queries with one or more syntax errors, one or more error responses from services, one or more services and/or service templates that cannot be found, and/or the like.

FIG. 5 is a simplified diagram of the processing of an EQL query 510 using method 400 according to some examples. As shown in FIG. 5, EQL query 510 is representative of a type of EQL query that might be used by a purchasing application. EQL query 510 specifies that several vendors are to be consulted regarding the fulfillment of an order. Each of the several vendors is represented by a candidate service identified in the FROM clause of EQL query 510. The candidate services include candidate services of two types, one for wood suppliers (WoodSupplier1 and WoodSupplier2) and a second for nail suppliers (NailSupplier). The min aggregator is used in conjunction with a services template called OrderPriceComputation that includes directions and/or scripting for submitting items from the order to each of the respective supplier servicers (WoodSupplier1, WoodSupplier2, and NailSupplier) to determine a cost for the order. By using the min operator, the combination of suppliers with the lowest cost is to be selected. EQL query 510 further includes one filter that places the additional restriction on the combinations of suppliers in that any order is to be shipped (i.e., cannot be delayed) more than 10 days. Once the combination of suppliers that can satisfy the shipping criteria and has the lowest cost is identified, the order is processed using the actions identified by the services OrdersService and LogService. Although not shown in FIG. 5, the request for services that includes EQL query 510 may further include the list of items that form the order. The application of method 400 to EQL query 510 is explained in further detail below.

During process 420, EQL query 510 is parsed by a query service system, such as query service system 120 and/or 240. Using the terms “SELECT”, “FROM”, and “WHERE”, the actions as represented by the services OrdersService and LogService are identified from the SELECT clause, the candidate services WoodSupplier1, WoodSupplier2, and NailSupplier are identified from the FROM clause, and the aggregator min, the services template OrderPriceComputation, and the filter order.delay<=0 are identified from the WHERE clause.

During process 430, a type is determined for each of the candidate services WoodSupplier1, WoodSupplier2, and NailSupplier. Based on metadata associated with WoodSupplier1, WoodSupplier2, and NailSupplier, it is determined that WoodSupplier1 and WoodSupplier2 are services with a type associated with a wood supplier and NailSupplier is a service with a type associated with a nail supplier.

During process 440, combinations of the candidate services WoodSupplier1, WoodSupplier2, and NailSupplier are determined based on the types determined during process 430. One service of each type is added to each combination. Because there are two services of the type associated with a wood supplier and one service of the type associated with a nail supplier, two combinations are determined. A first combination with WoodSupplier1 and NailSupplier and a second combination with WoodSupplier2 and NailSupplier are determined.

During process 450, each of the combinations determined during process 440 are applied using the services template OrderPriceComputation. Order details 520, as found in the request for services that includes EQL query 520 is sent to each combination of candidate services. Order details 520 may include a list of items that are to be ordered. The OrderPriceComputation template includes instructions for dividing up the items in order details 520 based on the type of supplier that can provide the respective item. Some of the items may be ordered from a wood supplier and others from a nail supplier. OrderPriceComputation also specifies how to send a request to the respective wood or nail supplier to receive a price and shipping quotation. As shown in box 530, OrderPriceComputation is used to request a price and shipping quote based on order details 520 from the combination including WoodSupplier1 and NailSupplier. A response 535 including a price of 3500 is received from WoodSupplier1 and NailSupplier as well as a delay of 5. Similarly, box 540 shows OrderPriceComputation being used to request a price and delivery quote based on order details 520 from the combination including WoodSupplier2 and NailSupplier. A response 545 is received from WoodSupplier2 and NailSupplier including a price of 4200 as well as a delay of 3. The requests for quotes from WoodSupplier1, WoodSupplier2, and/or NailSupplier may be made serially, one after the other, in parallel, or in some combination of the two. For EQL query 510, the order is not particularly relevant.

During process 460, the filter order.delay<=10 is applied to each of the responses received during process 450. In some cases, this may result is elimination (filtering out) of some of the responses; however, in this case, both responses 535 and 545 satisfy the filter. Response 535 includes a delay of 5, which is less than or equal to 10 and response 545 includes a delay of 3, which is less than or equal to 10.

During process 470, the aggregation min is applied to each of the responses that passed the filtering of process 460. This is shown in box 550 where min is applied to price 3500 from response 535 and to price 4200 from response 545. Min identifies that the combination of WoodSupplier1 and NailSupplier results in the minimum result. During process 480, WoodSupplier1 and NailSupplier are selected as the preferred combination of candidate services.

During process 490, the actions OrdersService and LogService are applied to the preferred combination of WoodSupplier1 and LogService. OrdersService places the actual order for the items in order details 520 by using the selected wood supplier, WoodSupplier1, and the selected nail supplier, NailSupplier, as represented in box 560. LogService is used to record the purchase transaction as represented in box 570.

The example of EQL query 510 demonstrates the ability to handle a request for services that uses at least short-term state as well as selection from among many choices. The expanding of processes 430 and 440 show how a relatively simple query may be used to detect and apply all of the possible combinations among candidate services without explicitly describing each combination. The consolidation of processes 450-480 show how the same query provides short-term state that supports the selection of a preferred combination using an aggregation. Thus, EQL query 510 may be used to test various possible combinations of candidate services that may satisfy zero or more criteria (filters) to find a preferred combination of candidate services (aggregation) without developing a custom application or implementing a separate state mechanism.

The service query system and EQL queries may be used to make other service requests that may distinguish between multiple options. For example, an EQL query like “SELECT TheService FROM ext1, ext2, ext3 WHERE first TestLatencyService” may be used to determine the processing and/or communication latency associated with candidate services ext1, ext2, and ext3 to determine which of these candidate services provides the best latency.

Some examples of service query system 120 and/or 240 may include non-transient, tangible, machine readable media that include executable code that when run by one or more processors (e.g., processor 220) may cause the one or more processors to perform the processes of method 400 as described above. Some common forms of machine readable media that may include the processes of method 400 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method of processing a request for services, the method comprising:
receiving a first request for services from a client, the first request for services comprising a service query including identifiers for an action, one or more candidate services, a services template, and an aggregation;
parsing the services query to identify the action, the candidate services, the services template, and the aggregation;
determining one or more combinations of candidate services based on types of the candidate services;
applying the services template to each of the combinations of candidate services to determine results for each of the combinations of candidate services;
aggregating the results based on the aggregation;
selecting a preferred combination of candidate services based on the applied aggregation; and
forwarding the results corresponding to the preferred combination to the action.

2. The method of claim 1, further comprising returning a response received from the action to the client.

3. The method of claim 1 wherein forwarding the results corresponding to the preferred combination to the action comprises:
sending a second request for services, including the results corresponding to the preferred combination, to the action; and
receiving a response from the action.

4. The method of claim 1, further comprising determining a type of each of the candidate services based on metadata associated with each of the candidate services.

5. The method of claim 1, further comprising receiving a registration request for a first candidate service, the registration request comprising metadata identifying a type of the first candidate service.

6. The method of claim 1 wherein determining the one or more combinations of candidate services based on the types of the candidate services comprises:
dividing the candidate services into one or more sets based on the types, each of the one or more sets including candidate services of a corresponding type selected from the types; and
generating a Cartesian product of the sets.

7. The method of claim 1 wherein applying the services template to each of the combinations of candidate services to determine the results for each of the combinations of candidate services comprises:
determining one or more first candidate services associated with a first combination of candidate services selected from the combinations of candidate services;
sending a corresponding second request for services to each of the first candidate services based on the services template; and
receiving a corresponding response from each of the first candidate services.

8. The method of claim 1 wherein the services template includes a script with one or more placeholders.

9. The method of claim 1, further comprising retrieving the services template from a template store.

10. The method of claim 1, further comprising filtering each of the combinations of candidate services based on a filter included in the services query.

11. The method of claim 10 wherein filtering each of the combinations of candidate services based on the filter comprises comparing a message property included in the results to a constant.

12. The method of claim 1 wherein the aggregation is selected from a group of functions consisting of first, last, min, max, median, and average.

13. The method of claim 1 wherein the aggregation includes a statistical function.

14. A service query system comprising:
a router;
a gateway that receives a first request for services from a client, the request for services comprising a service query including identifiers for an action, one or more candidate services, a services template, and an aggregation;
an expander that receives the service query from the gateway and determines one or more combinations of candidate services based on types of the candidate services;
a consolidator that receives the combinations of candidate services from the expander, applies the services template to each of the combinations of candidate services to determine results for each of the combinations of candidate services by sending one or more second requests for services to the candidate services using the router, aggregates the results based on the aggregation, and selects a preferred combination of candidate services based on the applied aggregation; and
an orchestrator that receives the results and the preferred combination of candidate services from the consolidator and forwards the results corresponding to the preferred combination to the action by sending a third request for service to the action using the router.

15. The service query system of claim 14 wherein the expander further:
divides the candidate services into one or more sets based on the types, each of the one or more sets including candidate services of a corresponding type selected from the types; and
generates a Cartesian product of the sets.

16. The service query system of claim 14 wherein the consolidator further:
determines one or more first candidate services associated with a first combination of candidate services selected from the combinations of candidate services;
sends a corresponding one of the second requests for services to each of the first candidate services based on the services template; and
receives a corresponding response from each of the first candidate services.

17. The service query system of claim 14 wherein the consolidator further retrieves the services template from a template store.

18. The service query system of claim 14 wherein the service query system is part of an enterprise services bus.

19. A non-transitory machine-readable medium comprising a first plurality of machine-readable instructions which when executed by one or more processors associated with an enterprise services bus (ESB) are adapted to cause the one or more processors to perform a method comprising:
receiving a first request from a client, the first request comprising an ESB query language (EQL) statement including clauses for designating an action, one or more services, a template, and a consolidation function;
parsing the EQL statement to identify the action, the services, the template, and the consolidation function;
separating the services into one or more sets based on types of the services, each of the one or more sets including services of a corresponding type selected from the types;
forming groups of services by generating different combinations of services by selecting one service from each of the sets;
for each group in the groups of services, sending corresponding second requests to each of the services in the group based on the template and receiving corresponding responses;
consolidating the responses to the second requests based on the consolidation function;
selecting a preferred group of services from the groups of services based on the results of the consolidation;
sending a third request, including the results corresponding to the preferred group of services, to the action; and
receiving a response from the action.

20. The non-transitory machine-readable medium of claim 19, further comprising a second plurality of machine-readable instructions which when executed by the one or more processors are adapted to cause the one or more processors to perform a method comprising filtering each of the groups of services based on a logical expression included in the EQL statement.
